(19) United States
(12) Patent Application Publication
(10) Pub. No.: US 2001/0029705 A1
(43) Pub. Date: Oct. 18, 2001

(54) Composition and method for polishing magnetic disk substrate, and magnetic disk polished therewith

(76) Inventor: Norihiko Miyata, Nagano (JP)

Correspondence Address: SUGHRUE, MION, ZINN, MACPEAK & SEAS, PLLC, Suite 800, 2100 PENNSYLVANIA AVENUE, N.W., WASHINGTON, DC, 20037-3213, US

(21) Appl. No.: 09/748,111

(22) Filed: Dec. 27, 2000

Related U.S. Application Data
(60) Provisional application No. 60/246,593, filed on Nov. 8, 2000.

(30) Foreign Application Priority Data
Dec. 27, 1999 (JP) H11-369095
Jan. 26, 2000 (JP) 2000-016614

(51) Int. Cl. C09G 1/02; C09K 3/14

(52) U.S. Cl. 51/308; 106/3

(57) ABSTRACT

A composition for polishing magnetic disk substrates having an Ni—P plating, comprising water, silicon oxide, a metal coordination compound, and an oxidizing agent. The composition may further contain a pH adjusting agent.

### CROSS REFERENCE TO RELATED APPLICATIONS

This application is based on the provisions of 35 U.S.C. Article 111(a) with claiming the benefit of filing date of U.S. provisional application Ser. No. (not identified) filed on Nov. 8, 2000 under the provisions of 35 U.S.C. 111(b), pursuant to 35 U.S.C. Article 119(e) (1).

### BACKGROUND OF THE INVENTION

1. Field of the Invention

The present invention relates to a composition and method for polishing a magnetic disk substrate and more particularly to a composition for polishing a magnetic disk substrate which can produce a magnetic disk surface having high precision suitable for allowing a magnetic head to fly at a low flying height. The present invention also relates to a magnetic disk substrate obtained by polishing using such a polishing composition and polishing method.

2. Description of Related Art

In an outer memory device of a computer or word processor, magnetic disks (memory hard disks) are widely used as means enabling high speed access. A typical example of such a magnetic disk is one which comprises a substrate composed of an Al alloy substrate having an electroless NiP plating on its surface and a Cr alloy subbing film, a Co alloy magnetic film, and a carbon protective film sequentially formed by sputtering on the substrate after having polishing the surface thereof.

If there remain on the surface of a magnetic disk protrusions having heights not smaller than the fly height of the magnetic head, the magnetic head flying at high speeds and at high fly heights above the surface of the magnetic disk would collide against the protrusions to cause damages. Also, if a magnetic disk substrate has protrusions or polishing flaws, a Cr alloy subbing film or Co alloy magnetic film formed on the substrate would have protrusions on the surface thereof or cause defects attributable to the polishing flaws so that the resulting magnetic disk would not have a smooth surface with high precision. Therefore, to increase precision of the surface of the disk, it is necessary to polish the substrate with high precision.

For this reason, for polishing magnetic disk substrates, many compositions have been proposed as compositions for polishing that could eliminate or decrease the height of protrusions as much as possible and produce less polishing flaws.

In particular, since Unexamined Published Japanese Patent Application No. Hei 10-121035 (which uses a composition containing titania with aluminum nitrate) uses titanium oxide particles of submicron order as abrasive grains, higher surface precision and higher polishing speed than conventional ones can be achieved with ease. However, under the circumstances, the level of surface precision which is required recently is difficult to attain due to the influence of the hardness of abrasive grain material.

The compositions described in Unexamined Published Japanese Patent Application No. Hei 9-204657 (which uses a composition containing colloidal silica with aluminum nitrate and anti-gelling agent) and Unexamined Published Japanese Patent Application No. Hei 9-204658 (which uses a composition containing fumed silica with aluminum nitrate) use silicon oxide fine particles having low hardness as abrasive grain so that surface precision can be obtained with ease but it is difficult to attain polishing speeds that can be used in current practical production.

To increase polishing speed, on one hand, many oxidizing agents have heretofore been proposed and put into practice and on the other hand use of Fe salts has been proposed (Unexamined Published Japanese Patent Application No. Hei 10-204416). However, these also fail to give sufficient polishing speeds that can be used current practical production.

The quality that compositions for polishing aluminum magnetic disk substrates enabling high density magnetic recording are required to have is to be able realization of a high precision disk surface that enables floating of the head at low fly height.

Therefore, there has been a keen demand for a polishing composition and method for polishing a magnetic disk substrate as well as a magnetic disk substrate obtained by using such a polishing composition or polishing method that can realize such a high precision disk surface.

### SUMMARY OF THE INVENTION

Therefore, an object of the present invention is to provide a composition for polishing magnetic disk substrates which leads to a magnetic disk with its surface having small surface roughness without the occurrence of protrusions or polishing flaws to enable to realize high density recording and in addition enables the polishing at economical speeds.

Another object of the present invention is to provide a method for polishing magnetic disk substrates using such a polishing composition.

Still another object of the present invention is to provide a magnetic disk substrate, preferably a magnetic disk substrate having an NiP plating, preferably formed by electroless plating, obtained by polishing a magnetic disk substrate using such a polishing composition or polishing method.

The present inventor has made extensive study on abrasives for realizing high precision polished surface required for low fly height type aluminum magnetic disks and as a result, they have discovered a composition for polishing that exhibits excellent properties in polishing aluminum magnetic disks, particularly those with Ni—P plating, thus accomplishing the present invention.

That is, the present invention basically includes the followings.

(1) A composition for polishing magnetic disk substrates, comprising water, silicon oxide, a metal coordination compound, and an oxidizing agent.

(2) A composition for polishing as described in (1) above, further comprising a pH adjusting agent.

(3) The composition for polishing as described in (1) above, wherein the metal coordination compound is a metal chelate.

(4) The composition for polishing as described in (3) above, wherein the metal chelate is an iron salt with EDTA.

(5) The composition for polishing as described in (4) above, wherein the iron salts with EDTA is at least one selected from monoammonium salt or monosodium salt.

(6) The composition for polishing as described in (1) above, wherein the oxidizing agent is ammonium peroxodisulfate.

(7) The composition for polishing as described in (1) above, wherein the silicon oxide is at least one selected from colloidal silica, fumed silica, and white carbon.

(8) The composition for polishing as described in (1) above, wherein secondary particles of the silicon oxide have an average particle diameter of about 0.03 to about 0.5 μm.

(9) The composition for polishing as described in (1) above, wherein pH is about 1 to about 8.

(10) The composition for polishing as described in (2) above, wherein the pH adjusting agent is at least one selected from nitric acid and a phosphonic acid compound.

(11) The composition for polishing as described in (10) above, wherein the phosphonic acid compound is at least one selected from phosphoric acid, 1-hydroxyethane-1,1-diphosphonic acid, and aminotrimethylenephosphonic acid.

(12) The composition for polishing as described in (1) above, wherein the magnetic disk substrate is a magnetic disk substrate having an NiP plating.

(13) A method for polishing a magnetic disk substrate comprising polishing a magnetic disk substrate with a polishing composition as described in (1) above.

(14) A method for polishing a magnetic disk substrate as claimed in claim 13, wherein the magnetic disk substrate is a magnetic disk substrate having an NiP plating, comprising preventing or suppressing conversion of trivalent Fe ions to Fe oxides or hydroxides.

(15) The method as described in (14) above, wherein pH is adjusted to prevent or suppress the conversion of Fe ions.

(16) The method as described in (14) above, wherein a complex is added to hold the Fe ions.

(17) A magnetic disk substrate obtained by using a polishing composition as described in (1) above.

(18) The magnetic disk substrate as described in (17) above, wherein the substrate has an NiP plating.

(19) The magnetic disk substrate as described in (18) above, wherein the substrate has an NiP plating applied by electroless plating.

(20) A magnetic disk substrate obtained by polishing a magnetic disk substrate by a method as described in (14) above.

(21) The composition for polishing as described in (3) above, further comprising a pH adjusting agent.

(22) The composition for polishing as described in (4) above, further comprising a pH adjusting agent.

(23) The composition for polishing as described in (5) above, further comprising a pH adjusting agent.

(24) The composition for polishing as described in (6) above, further comprising a pH adjusting agent.

(25) The composition for polishing as described in (7) above, further comprising a pH adjusting agent.

(26) The composition for polishing as described in (8) above, further comprising a pH adjusting agent.

(27) The composition for polishing as described in (9) above, further comprising a pH adjusting agent.

The above and other objects, effects, features and advantages of the present invention will become more apparent from the following description of preferred embodiments.

### DETAILED DESCRIPTION OF THE INVENTION

Silicon oxide contained as an abrasive in the composition for polishing of the present invention is not particularly limited and may be colloidal silica, fumed silica, or white carbon. They may be used alone or two or more of them may be used together. The average particle diameter of secondary particles of silicon oxide is preferably about 0.03 to about 0.5 μm, more preferably about 0.04 to about 0.2 μm. The average particle diameter of secondary particles of silicon oxide is a value measured by a laser Doppler frequency analyzing particle size distribution meter, Micro Track UPA150 (manufactured by Honeywell Corp.).

Greater secondary particle size of silicon oxide makes it easier to suppress gelling or agglomeration of finer particles. However, it also leads to higher probability of existence of coarser particles and hence causes polishing flaws to occur. Therefore, the average particle diameter of secondary particles of silicon oxide contained as an abrasive in the composition for polishing of the present invention is preferably from about 0.03 to about 0.5 μm and more preferably from about 0.04 to about 0.2 μm.

The metal coordination compound used in the present invention includes, though not particularly limited, complex salts in a broad sense, such as metal chelate compounds. The metal chelate compounds include metal salts containing EDTA (ethylenediaminetetraacetic acid), N-hydroxyethylenediaminetriacetic acid (NHEDTA), ammoniatriacetic acid (NTA) or the like as a ligand. They may be used alone or two or more of them may be used together. The metal in the metal salts are suitably those which have high oxidizing power against Ni, which can exist in different valence states other than the valence of 0 and of which the oxidation number in the most stable valence state is greater than the oxidation number(s) of other valence(s). In particular, iron (Fe) is preferred. The reason for this would be as follows. Fe is more stable when its ions are trivalent than divalent and the trivalent Fe ions oxidize Ni to produce divalent Fe ions. The oxidized Ni forms hydroxide or oxide in the presence of water. Polishing proceeds by removing the hydroxide or oxide with abrasive grains. The divalent Fe ions are converted to trivalent ions and held as an iron salt of a metal chelate compound, for example, EDTA. It is presumed that these reactions be repeated.

The metal chelate compound used in the present invention is not particularly limited but iron salt with EDTA is preferred. In particular, the iron salt is more preferably monoammonium salt or monosodium salt. If it is intended to increase only polishing speed, it will be effective to add a large amount of iron nitrate, iron chloride or the like. However, this not only fails to give high precision surface but also their addition causes the problem of corrosion of the apparatus.

The oxidizing agent used in the present invention includes, though not particularly limited, peroxoacid salts such as ammonium salt, potassium salt, and sodium salt of peroxodisulfuric acid, ammonium salt and sodium salts of peroxoboric acid, and sodium salt and potassium salt of peroxodiphosphoric acid, permanganic acid salts, bichromic acid salts, nitric acid salts, sulfuric acid salts, peroxides such as hydrogen peroxide, perchloric acid salts, and so on. They may be used alone or two or more of them may be used together. Peroxoacid salts are preferred. Among them, ammonium peroxodisulfate is particularly preferred.

The oxidizing agent oxidizes not only Fe that has been converted to divalent after it oxidized Ni but also Ni. Therefore, due to the synergistic effects the polishing speed increases. However, the Fe ions which returned to the trivalent state from the divalent state by use of the oxidizing agent will be converted to hydroxide or oxide in the absence of complexes such as chelate compounds, so that in this state trivalent Fe will not function effectively.

For this reason, if Fe ions are held by a complex they will not be converted to hydroxide or oxide and the Fe ions will continue to function effectively, resulting in that a further increased polishing speed can be obtained. However, increased stability of complex salt leads to a state where the ions cannot be held and the effect of complex is decreased. Trivalent iron salts with EDTA have high complex formation constants and are extremely stable, so that they will not change Fe to hydroxide or oxide and allow it to effectively function as trivalent Fe ion, thus giving high polishing speed.

In the case where the abrasive grains comprise colloidal silica, gelling may arise. However, addition of iron salts with EDTA will improve dispersibility so that gelling can be inhibited.

Use of iron salts with EDTA as the Fe source, high polishing speed can be obtained even when the pH of composition for polishing is set to about 1 to about 8. Therefore, use of iron salts with EDTA is very useful in respect of stability of trivalent iron, prevention of gelling, and pH.

In the case where the concentration of silicon oxide in the composition for polishing of the present invention is less than about 3% by mass (hereinafter, all % means % by mass unless otherwise indicated specifically), polishing speed is increased according as the concentration increases. Further, according as the concentration increases, the polishing speed increases. However, if it exceeds about 30%, not only no increase in polishing speed will be observed but also gelling tends to occur particularly in the case of colloidal silica. Taking into consideration also economy, practically about 30% is the upper limit. Therefore, the concentration of silicon oxide in the composition is preferably in the range of from about 3 to about 30%, more preferably from about 5 to about 15%.

The amount of metal coordination compound used in the composition for polishing of the present invention is preferably from about 1 to about 10% and more preferably from about 2 to about 6%.

If the addition amount of metal coordination compound is less than about 1%, the effect of promotion of abrasion is low and moreover gelling tends to occur. If the addition amount of metal coordination compound exceeds above about 10%, no further improvement in the effect of promoting abrasion can be expected.

The amount of oxidizing agent used in the present invention is preferably about 1 to about 10%, and more preferably about 3 to about 7%.

If the amount of oxidizing agent added is less than about 1%, the effect of promoting abrasion will be low. Whereas if the amount of the oxidizing agent added exceeds about 10%, the effect of promoting abrasion will not be increased further.

The pH adjusting agent used in the present invention is not limited particularly. It is preferably at least one selected from nitric acid and a phosphonic acid compound. More specifically, the phosphonic acid compound includes phosphoric acid, 1-hydroxyethane-1,1-diphosphonic acid (C₂H₆O₇P₂) or aminotrimethylenephosphonic acid (C₂H₁₂O₉P₃N). They may be used alone or two or more of them may be used together. It is preferred that these be added in amounts no more than about 2%. This adjusts the pH of the composition to preferably about 1 to about 8.

Note that the concentrations of the respective components described above are those concentrations at which magnetic disk substrates are actually polished. In the case where polishing compositions are produced, transported and soon, it is efficient that they are made to have higher concentrations than the above-described concentrations and are diluted before they can be used.

In the present invention, the polishing composition for magnetic disk substrates may contain those additives ordinarily used for polishing compositions, for example, surfactants, antiseptics and the like in addition to the above respective components. However, care must be taken in selecting their type and addition amount so that there will occur no gelling.

The polishing composition of the present invention can be prepared by suspending silicon oxide in water and adding thereto a metal coordination compound such as iron salts with EDTA, an oxidizing agent such as ammonium peroxodisulfate, a pH adjusting agent or the like. When in use, while a mixture of all the components may be diluted before use, a method may also be used in which the two groups of components to be added are prepared in advance, for example, one containing water, silicon oxide and a metal coordination compound and another containing water, an oxidizing agent and a pH adjusting agent and the two groups are mixed upon use.

The polishing composition of the present invention can be used advantageously to substrates for high density recording (usually, having a recording density of 3 Gbit/inch² or more), typically magnetic disks for magnetic heads utilizing magnetic resistance (MR) effect. It is also effectively applied to magnetic disks having recording densities below 3 Gbit/inch² from the viewpoint of increased reliability.

The magnetic hard disk substrates which the polishing composition of the present invention is applicable to is not particularly limited. However, when the composition of the present invention is applied to aluminum substrates (including alloys), in particular to those substrates plated with NiP, for example, by electroless plating, a high quality polished surface can be obtained industrially advantageously because the mild mechanical polishing action by silicon oxide, the redox ability of Fe in iron salts with EDTA, the oxidation ability of ammonium peroxodisulfate, and the stability of Fe ions as a complex of iron salts with EDTA function as described above.

The method of polishing is a method in which a polishing pad generally used for slurry abrasives is slided on a magnetic disk substrate and the pad or substrate is rotated with feeding the slurry between the pad and the substrate.

With magnetic disks produced from substrates polished with the polishing composition of the present invention, minute failures such as micro pits, micro scratches and the like will occur in very low frequencies and their surface roughness (Ra) ranges from about 2 to about 3 angstroms and thus is excellent in smoothness.

### EXAMPLES

Hereinafter, examples of the present invention will be explained concretely. However, the present invention should not be construed as being limited to these examples.

Table 1 shows the silicon oxide (silica) and titania used in Examples and Comparative Examples.

### Examples 1 to 11

To colloidal silica (Siton HT-50F) produced by DuPont were added water, ammonium iron EDTA, ammonium peroxodisulfate, and pH adjusting agent in proportions shown in Table 2 to prepare various aqueous polishing compositions. Polishing was performed with each of them using the polishing apparatus and polishing conditions set forth below. The results obtained are shown in Table 2.

The particle diameter was measured using a Laser Doppler Frequency Analysis Particle Size Meter and Micro Track UPA150 (Honeywell). The obtained particle sizes are shown in Table 1.

### Examples 12 and 13

White carbon (E-150J) and fumed silica (AEROSIL 50) were pulverized by a medium agitating mill and coarse grains were removed therefrom by particle size selection to obtain silicon oxide whose secondary particles having an average particle diameter of 0.1 μm. Then, water, ammonium iron EDTA, ammonium peroxodisulfate, and pH adjusting agent were added in proportions shown in Table 2 to prepare various aqueous polishing compositions. With these, polishing was performed using a polishing apparatus and polishing conditions. Table 2 shows the results obtained.

Polishing

Substrate used:

3.5-inch aluminum disk plated with NiP by electroless plating Polishing apparatus and polishing conditions used:

| | |
|---|---|
| Polishing tester; | 4-way double polishing machine |
| Polishing pad; | Suede type (Polytex DG, |
| | manufactured by Rodale) |
| Rotation number of lower stool; | 60 rpm |
| Slurry feed rate; | 50 ml/min |
| Polishing time; | 5 minutes |
| Processing pressure; | 50 g/cm² |

Evaluation of Polishing Property

Polishing rate; Calculated from a difference in weight before and after polishing an aluminum disk

Surface roughness; Talistep, Talidata 2000 (manufactured by Rank Tailor Hobson)

Depth of polishing damage and polishing pit: Configuration analysis was performed by three-dimensional mode of a stylus type surface analyzer P-12 (manufactured by TENCOR) and depth was obtained therefrom.

Table 2 shows the results of evaluation of the polishing properties. In Table 2, polishing flaw “A” means that the depth of polishing flaw is 5 nm or less and pit “A” means that the depth of pit is 5 nm or less. Polishing flaw “B” means that the depth of polishing flaw is 5 nm to 10 nm and pit “B” means that the depth of pit is 5 nm to 10 nm. In Examples and Comparative Examples, no flaw or pit having a depth of above 10 nm appeared.

### Comparative Examples 1 to 5

To colloidal silica produced by DuPont Co. (Siton HT-50F) were added water, iron salts with EDTA, ammonium peroxodisulfate, and iron nitrate in proportions shown in Table 2 to prepare an aqueous polishing composition and polishing was performed in the same manner as in Examples. Table 2 shows the results.

### Comparative Example 6

Titanium oxide produced by Showa Titanium Co., Ltd. (Super Titania F-2) was pulverized by a medium agitating mill and coarse grains were removed therefrom by particle size selection to obtain titanium oxide whose secondary particles having an average particle diameter of 0.3 μm. Then, water and aluminum nitrate were added in proportions shown in Table 2 to prepare an aqueous polishing composition. With this, polishing was performed in the same manner as in Examples. Table 2 shows the results.

TABLE 1

| | | Primary | Secondary |
|---|---|---|---|
| | | Particle | Particle |
| | | Size | Size |
| | Trade Name | (μm) | (μm) |
| Silicon oxide 1 (Silica 1) | Siton HT-50F | 0.05 | 0.05 |
| Silicon oxide 2 (Silica 2) | E-150J | 0.03 | 0.1 |
| Silicon oxide 3 (Silica 3) | AEROSIL 50 | 0.05 | 0.1 |
| Titanium oxide (titania) | F-2 | 0.06 | 0.3 |

TABLE 2

| | | | Ammonium | | | | | | | |
|---|---|---|---|---|---|---|---|---|---|---|
| | | Ammonium | peroxo-di | | | | | Surface | | |
| | Abrasive | Iron EDTA | sulfate | pH Adjusting agent | | | Polishing | roughness | Polish- | |
| | Kind Amount | Amount | Amount | | Amount | | rate | (Ra) | ing | |
| | (wt %) | (wt %) | (wt %) | Kind | (wt %) | pH | (μm/min) | (nm) | flaw | Pit |
| Ex. 1 | Silica (1) 2 | 4.0 | 5.0 | HEDP | 0.2 | 3 | 0.20 | 0.2 | A | A |
| Ex. 2 | Silica (1) 6 | 4.0 | 5.0 | HEDP | 0.2 | 3 | 0.22 | 0.2 | A | A |
| Ex. 3 | Silica (1) 15 | 4.0 | 5.0 | HEDP | 0.2 | 3 | 0.23 | 0.2 | A | A |
| Ex. 4 | Silica (1) 6 | 1.0 | 5.0 | HEDP | 0.2 | 3 | 0.20 | 0.2 | A | A |
| Ex. 5 | Silica (1) 6 | 10.0 | 5.0 | HEDP | 0.2 | 3 | 0.22 | 0.2 | A | A |
| Ex. 6 | Silica (1) 6 | 4.0 | 1.0 | HEDP | 0.2 | 3 | 0.20 | 0.2 | A | A |
| Ex. 7 | Silica (1) 6 | 4.0 | 10.0 | HEDP | 0.2 | 3 | 0.23 | 0.2 | A | A |
| Ex. 8 | Silica (1) 6 | 4.0 | 5.0 | — | | 6 | 0.20 | 0.2 | A | A |
| | | | | Methyl- | | | | | | |
| | | | | phosphonic | | | | | | |
| Ex. 9 | Silica (1) 6 | 4.0 | 5.0 | acid | 0.3 | 3 | 0.20 | 0.2 | A | A |
| | | | | Phosphoric | | | | | | |
| Ex. 10 | Silica (1) 6 | 4.0 | 5.0 | acid | 0.2 | 3 | 0.21 | 0.2 | A | A |
| | | | | Nitric | | | | | | |
| Ex. 11 | Silica (1) 6 | 4.0 | 5.0 | acid | 0.1 | 3 | 0.22 | 0.2 | A | A |
| Ex. 12 | Silica (2) 6 | 4.0 | 5.0 | HEDP | 0.2 | 3 | 0.22 | 0.2 | A | A |
| Ex. 13 | Silica (3) 6 | 4.0 | 5.0 | HEDP | 0.2 | 3 | 0.21 | 0.2 | A | A |

| | | | | | | | | | |
|---|---|---|---|---|---|---|---|---|---|
| C.Ex. 1 | Silica (1) 6 | 4.0 | — | — | 6 | 0.12 | 0.2 | B | A |
| C.Ex. 2 | Silica (1) 6 | — | 5.0 | — | 6 | 0.15 | 0.2 | A | A |
| C.Ex. 3 | Silica (1) 6 | Iron | — | — | 2 | 0.18 | 0.2 | A | A |
| | | nitrate 2.0 | | | | | | | |
| C.Ex. 4 | Silica (1) 6 | Iron | — | — | 3 | 0.09 | 0.2 | A | A |
| | | nitrate 0.3 | | | | | | | |
| C.Ex. 5 | Silica (1) 6 | Iron | 5.0 | — | 3 | 0.16 | 0.2 | A | A |
| | | nitrate 0.3 | | | | | | | |
| C.Ex. 6 | Titania 6 | Aluminum | — | — | 3 | 0.21 | 0.4 | B | B |
| | | nitrate 5.0 | | | | | | | |

HEDP: 1-Hydroxyethane-1,1-diphosphonic acid

When disks are polished with the polishing composition of the present invention, disks will have very small surface roughness and can be polished at high speeds. Magnetic disks using the thus polished disks are useful as a low fly height hard disks and enable high density recording.

In particular, magnetic disks using the polished disks have high availability as high density recording media (having a recording density of 3 Gbit/inch² or more), representative example of which is a media for MR head utilizing magnetic resistance effect. However, it is also useful for in other media in view of the fact that it is a highly reliable medium.

The invention may be embodied in other specific forms without departing from the spirit or essential characteristics thereof. Therefore, the present embodiment is to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A composition for polishing magnetic disk substrates, comprising water, silicon oxide, a metal coordination compound, and an oxidizing agent.

2. The composition for polishing as claimed in claim 1, further comprising a pH adjusting agent.

3. The composition for polishing as claimed in claim 1, wherein the metal coordination compound is a metal chelate.

4. The composition for polishing as claimed in claim 3, wherein the metal chelate is an iron salt with EDTA.

5. The composition for polishing as claimed in claim 4, wherein the iron salt with EDTA is at least one selected from monoammonium salt or monosodium salt.

6. The composition for polishing as claimed in claim 1, wherein the oxidizing agent is ammonium peroxodisulfate.

7. The composition for polishing as claimed in claim 1, wherein the silicon oxide is at least one selected from colloidal silica, fumed silica, and white carbon.

8. The composition for polishing as claimed in claim 1, wherein secondary particles of the silicon oxide have an average particle diameter of about 0.03 to about 0.5 μm.

9. The composition for polishing as claimed in claim 1, wherein pH is about 1 to about 8.

10. The composition for polishing as claimed in claim 2, wherein the pH adjusting agent is at least one selected from nitric acid and a phosphonic acid compound.

11. The composition for polishing as claimed in claim 10, wherein the phosphonic acid compound is at least one selected from phosphoric acid, 1-hydroxyethane-1,1-diphosphonic acid, and aminotrimethylenephosphonic acid.

12. The composition for polishing as claimed in claim 1, wherein the magnetic disk substrate is a magnetic disk substrate having an NiP plating.

13. A method for polishing a magnetic disk substrate comprising polishing a magnetic disk substrate with a polishing composition as claimed in claim 1.

14. A method for polishing a magnetic disk substrate as claimed in claim 13, wherein the magnetic disk substrate is a magnetic disk substrate having an NiP plating, comprising preventing or suppressing conversion of trivalent Fe ions to Fe oxides or hydroxides.

15. The method as claimed in claim 14, wherein pH is adjusted to prevent or suppress the conversion of Fe ions.

16. The method as claimed in claim 14, wherein a complex is added to hold the Fe ions.

17. A magnetic disk substrate obtained by using a polishing composition as claimed in claim 1.

18. The magnetic disk substrate as claimed in claim 17, wherein the substrate has an NiP plating.

19. The magnetic disk substrate as claimed in claim 18, wherein the substrate has an NiP plating applied by electroless plating.

20. A magnetic disk substrate obtained by polishing a magnetic disk substrate by a method as claimed in claim 14.

21. The composition for polishing as claimed in claim 3, further comprising a pH adjusting agent.

22. The composition for polishing as claimed in claim 4, further comprising a pH adjusting agent.

23. The composition for polishing as claimed in claim 5, further comprising a pH adjusting agent.

24. The composition for polishing as claimed in claim 6, further comprising a pH adjusting agent.

25. The composition for polishing as claimed in claim 7, further comprising a pH adjusting agent.

26. The composition for polishing as claimed in claim 8, further comprising a pH adjusting agent.

27. The composition for polishing as claimed in claim 9, further comprising a pH adjusting agent.
